(19) United States
(12) Patent Application Publication
(10) Pub. No.: US 2020/0009659 A1
(43) Pub. Date: Jan. 9, 2020

(54) Method and Device for Machining a Workpiece

(71) Applicant: DATRON AG, Mühltal (DE)

(72) Inventor: Rupert Flögel, Otzberg (DE)

(21) Appl. No.: 16/340,111

(22) PCT Filed: Oct. 6, 2017
(86) PCT No.: PCT/EP2017/075497

§ 371 Date: Apr. 6, 2019

(30) Foreign Application Priority Data
Oct. 7, 2016 (DE) 10 2016 119 147.7

(51) Int. Cl. B22F 3/24; B22F 3/105; B33Y 10/00; B33Y 40/00

(52) U.S. Cl. CPC B22F 3/24; B22F 3/1055; B33Y 10/00; B22F 2998/10; B22F 2003/1058; B22F 2003/247; B33Y 40/00

(57) ABSTRACT

In a method for machining a workpiece (1), the workpiece (1) is secured to a carrier element (2) by at least one connecting element (4) or is produced by a generative production method. In an embedding step, the workpiece (1) is introduced into a casting mould surrounding the workpiece (1) and a curing carrier material (16) surrounding the workpiece (1) is introduced into the casting mould, such that the workpiece (1) is embedded and fixed in the carrier material (16). In an exposure step, the carrier material (2) is separated from the workpiece (1) and the workpiece (1) is exposed from a side facing the carrier element (2), in order, in a subsequent second machining step, for it to be possible to machine the workpiece (1) partially embedded in the carrier material (16). The workpiece (1) can be produced by a generative production method on the carrier element (2), wherein at least one connecting element (4) that joins the workpiece (1) to the carrier element (2) is produced at the same time. Arranged on the carrier element (2) are protruding positioning elements (6), which, when the workpiece (1) is introduced into the casting mould (10), come into engagement with matching recesses in the casting mould, in order to define a position of the carrier element (2) with the workpiece (1) secured thereto relative to the casting mould and to allow subsequent referencing of the workpiece (1).

### TECHNICAL FIELD

The disclosure relates to a method for machining a workpiece, wherein the workpiece is fixed by a connecting element on a carrier element and is machined in a subsequent machining step.

### BACKGROUND

Various methods are known in practice in which a workpiece is arranged on a carrier element, in order then to arrange the carrier element in a machining machine and be able to machine the workpiece fixed on the carrier element with the machining machine. Generative manufacturing methods are also known, such as 3D printing processes or the selective laser melting process, in which the workpiece is manufactured on the carrier element.

In generative manufacturing of the workpiece, the workpiece is generated on the carrier element and is fixed and supported on the carrier element by way of suitable connecting elements, which are also termed “supports”. Even in a subsequent arrangement of the workpiece on the carrier element, however, it is advisable that the carrier element rather than the possibly very small and irregularly shaped workpiece is taken up and fixed by a locating device of a machining machine or a separate fixing device in order to carry out a subsequent machining step with a machining machine. The carrier element can be configured in a standardized manner here if applicable, in order to make a rapid insertion and fixing in the locating device or fixing device easier.

With regard to a take-up of the workpiece that is as dimensionally stable and precise as possible, the carrier element is normally manufactured from metal or from a high-strength and dimensionally stable plastic material.

Workpieces formed in any manner can be connected to the carrier element and can be taken up and fixed by the carrier element. In the case of workpieces that are produced by a generative manufacturing method on the carrier element, an undesirable displacement of the workpiece is to be prevented both during its manufacture and if applicable in a subsequent machining step while the workpiece is connected to the carrier element. In the case also of a workpiece produced in another way and fixed on the carrier element afterwards, an undesirable displacement of the workpiece during a subsequent machining step is to be prevented by the fixing on the carrier element. It is common to all known methods here that the workpiece is connected to the carrier element by at least one connecting element and is thereby positioned and fixed on the carrier element. The workpiece is prevented from shifting relative to the carrier element during the manufacturing and machining steps by the usually several connecting elements.

When using a generative manufacturing method to produce the workpiece, the at least one connecting element is also formed by the same manufacturing process before, during or immediately after the manufacture of the workpiece. Following the manufacture and machining of the workpiece, the workpiece can be released from the carrier element by severing the at least one connecting element or detaching it from the workpiece. Residues of the connecting element usually remain on the workpiece in this case, which then have to be removed manually afterwards with great effort.

Following its manufacture, the workpiece fixed on the carrier element could be machined and polished, coated or reshaped, for example, from a side facing away from the carrier element. To be able to machine the workpiece from a side facing the carrier element also, the workpiece must first be released from the carrier element to be freely accessible from this side. However, the fixing of the workpiece relative to the carrier element is terminated by this, so that the positioning of the workpiece brought about by the carrier element is eliminated. According to experience the workpiece can then no longer be taken up and fixed sufficiently precisely in a specifiable positioning relative to a machining machine, so that subsequent machining steps can no longer be machined with the accuracy that was achieved before the release of the workpiece from the carrier element. Carrier elements with a complex shape are also known, which are adapted to the workpiece to be held and can permit machining of the workpiece from various directions. Such carrier elements are often costly to manufacture, however, and cannot readily be used to hold workpieces configured in a different manner.

For machining the workpiece from the side facing the carrier element, it is also known to provide the carrier element with a recess or opening, so that the side of the workpiece facing the carrier element is accessible for a machining tool through this opening or recess. However, often only a restricted and insufficient machining of the workpiece is possible in this case, so that the workpiece must nevertheless be released from the carrier element to permit complete machining. It is also possible to produce the recesses or openings required for this in the carrier element before or during the machining of the workpiece, wherein the carrier element is destroyed thereby and is no longer suitable for subsequent take-up of another workpiece. In the case of a workpiece produced on the carrier element using a generative manufacturing method, the workpiece is usually fixed on the carrier element by a large number of connecting elements. For this reason machining of the side of the workpiece facing the carrier element is impossible or only possible to a limited extent, regardless of the configuration of the carrier element.

### SUMMARY

It is therefore regarded as an object of the present invention to design a method for machining a workpiece so that machining of the workpiece as precisely as possible from all sides is facilitated by simple means.

This object is achieved in that in an embedding step, the workpiece is inserted into a casting mold enclosing the workpiece and a curing carrier material enclosing the workpiece is introduced into the casting mold, so that the workpiece is embedded and fixed in the carrier material, that in an exposure step the carrier element is separated from the workpiece and the workpiece is exposed from a side facing the carrier element, and that in a subsequent machining step the workpiece is machined partially embedded into the carrier material. Due to the embedding of the workpiece into the carrier material, the workpiece is taken up and fixed, so that the workpiece is fixed in the casting mold even after separation from the carrier element. The casting mold or the carrier material can be taken up and fixed in a suitable locating device before the machining step. For this purpose the casting mold can have an adapter, in order to be taken up in an exact position and reliably in a locating device. It is likewise conceivable and advantageous for many applications if the casting mold has indexing displaying the orientation of the casting mold, which indexing is also transferred if applicable to the shaping of the cured carrier material.

According to an advantageous configuration of the inventive idea, it is provided that at least one fixing element is embedded into the carrier material in an edge region facing the casting mold, which fixing element is partly exposed following curing of the carrier material and removal of the casting mold and is used for take-up in a positioning device. The fixing element can have an attachment cone or a stepped or dovetailed shape, for example, in order to be able to be taken up and fixed in the positioning device in a positive-locking manner. The fixing element can also be used for automated handling and movement of the carrier material.

The carrier material expediently differs from the material of the workpiece, so that the carrier material can be removed as required without great effort and the workpiece can be exposed in areas, in order to permit machining of the workpiece on the exposed areas in the second machining step. The carrier element can be detached from the workpiece in this way and the workpiece can be machined from a side originally facing the carrier element without precise positional control and highly accurate take-up of the workpiece embedded in the carrier material being made difficult or impossible. The carrier material serves in this case for the positionally accurate and stable take-up and fixing of the workpiece separated from the carrier element. The carrier material is expediently selected here so that it guarantees a precise positioning and fixing of the workpiece embedded in the carrier material on the one hand, and on the other hand can be ablated and removed from the workpiece quickly and by simple means without the workpiece being damaged or a surface of the workpiece impaired in the process.

The carrier element may consist of a material adapted to the material of the workpiece or at least has a coating of an adapted material, so that the workpiece can be connected as reliably as possible to the carrier element and fixed thereon. The carrier element should provide a suitably adhesive surface for the workpiece in question. Any thermal tensions possibly occurring between the carrier element and the workpiece during a manufacturing step or machining step should be as small as possible.

According to a particularly advantageous configuration of the inventive idea, it is provided that the workpiece is manufactured by a generative manufacturing method on the carrier element and at least one connecting element connecting the workpiece to the carrier element is also manufactured. Examples of a generative manufacturing method are 3D printing and beam melting processes such as selective laser melting, electron beam melting or selective laser sintering. Using such a generative manufacturing method, three-dimensional workpieces can be manufactured progressively and in particular in layers from a curing base material or from a base material melted and solidified by suitable means. Since the workpiece is manufactured directly on the carrier element building on the connecting elements, the necessity for subsequent arrangement and fixing on the carrier element is eliminated. The carrier element is used here to locate the workpiece during the manufacturing process.

In many cases the workpiece must be machined following its formative generative construction to smooth or polish its surface, for example, to grind its surface or machine it to bring the shaping and surface roughness of the workpiece to specified final dimensions. For this other tools and if necessary even other machine tools are normally required than in the generative construction of the workpiece. If the workpiece has to be transferred between individual manufacturing and machining steps, for example from a first locating device in a first manufacturing apparatus to another locating device in a machining machine, the carrier element permits a precise arrangement of the workpiece, as its position relative to the carrier element is known, either due to the preceding manufacturing process on the carrier element or by its precise fixing and if applicable referencing on the carrier element.

To be able to use the casting mold also for a precise arrangement of the workpiece, it is provided that at least one protruding positioning element may be arranged on the carrier element or on the workpiece, which positioning element engages on the introduction of the workpiece into the casting mold with matching recesses in the casting mold, in order to specify a positioning of the carrier element with the workpiece fixed thereon relative to the casting mold. The arrangement and positioning of the casting mold relative to the carrier element and the workpiece can be specified in this way by simple means. The positioning elements can be projecting moldings, which are arranged, for example, on an edge of the carrier element or along a contact surface of the carrier element with the casting mold. Three or more positioning elements are preferably provided. Through three positioning elements, which are arranged, for example, along a circumferential edge of the carrier element at irregular intervals relative to one another, a clear position determination and orientation of the carrier element relative to the casting mold can be determined and specified.

The positioning elements can be manufactured separately and connected to the carrier element retrospectively. It is also possible in particular when using a generative manufacturing method for the workpiece to produce the positioning elements in the same manufacturing step together with the workpiece.

The carrier element can be configured disc-shaped or plate-shaped and have a level locating surface for the workpiece and the positioning elements. According to one advantageous configuration of the inventive idea, it is provided that the positioning elements are positioning pins projecting from the carrier element. The positioning pins can project substantially perpendicularly from the level locating surface and on connection of the casting mold to the carrier element can engage in recesses adapted thereto, for example blind holes, in the casting mold.

To separate the carrier element from the casting mold and the carrier material introduced into it with the workpiece embedded therein, the carrier element can be detached from the casting mold and the carrier material by a separation process along a separation plane that runs between the carrier element and the casting mold. A dividing line that is often suitable runs here in a parallel plane to the surface of the carrier element and transverse to the connecting elements projecting perpendicularly from it. The carrier element can then be cleaned and used again.

The positioning elements can expediently be formed as disposable parts, which in contrast to the carrier element are not to be used multiple times. In generative manufacturing of the workpiece and the positioning elements, the positioning elements cannot be used multiple times. The positioning elements, which project from the carrier element and engage with the casting mold, then likewise have to be separated from the carrier element. It would also be conceivable to design the positioning elements for multiple use and to connect them detachably to the carrier element before the embedding step, in order to remove the positioning elements again following curing of the carrier material before the carrier element is separated from the casting mold again by the separation method.

When using a generative manufacturing method for the workpiece and the positioning elements, it could be expedient for the positioning elements each to be connected via at least one connecting element to the carrier element. During the separation of the carrier element, not only the connecting elements by which the workpiece was connected to the carrier element but also the connecting elements of the positioning elements can then be separated, so that the positioning elements remain on or in the carrier material.

To promote a fixing of the positioning elements that is as stable and positionally accurate as possible, it can also be provided that the positioning elements are fixed directly on the carrier element without connecting elements, which are often formed thin and hollow-walled, being arranged between the positioning elements and the carrier element.

It is likewise possible that the positioning elements are fixed on the casting mold or formed thereon and can be brought into engagement with recesses adapted thereto in the carrier element.

A stabilization of the positioning elements and as precise a positioning as possible of the positioning elements relative to the workpiece can be promoted in that the positioning elements are connected to the workpiece by stabilization elements. The stabilization elements can be configured similarly to connecting elements or the supports known from generative manufacturing methods and can bring about a stabilizing connection of the workpiece to the relevant positioning element. Due to the composite effect the position of the workpiece relative to the positioning element is additionally determined and even during subsequent post-machining, for example, is additionally fixed.

To make separation of the carrier element from the casting mold and the cured carrier material therein easier, it can be provided that an interior space of the casting mold is not completely filled with the carrier material, but that a thin gap remains free on the surface of the carrier element arranged on top during the filling, so that the cured carrier material does not contact the carrier element.

To make separation of the carrier element from the casting mold easier and to make it easier, furthermore, to expose the workpiece embedded in the casting mold in the carrier material from a side facing the carrier element, it is provided that the casting mold is configured in multiple parts and following curing of the carrier material, is taken apart and demolded from the cured carrier material. The casting mold can consist, for example of two half-ring-shaped wall shells, which can be assembled into a wall formwork in the shape of a hollow cylinder and connected to the carrier element, so that a pot-shaped casting mold is formed. The carrier material can be poured into this pot-shaped casting mold, wherein the filling level should be sufficiently great to embed the workpiece or several workpieces, which are arranged on the carrier element, at least partially or fully into the curing carrier material. Following curing of the carrier material, the two half-ring-shaped wall shells can be detached from one another and from the carrier element again.

According to one configuration of the inventive idea, it is likewise possible for the casting mold to have a casting mold base element and a side wall ring element, which can be connected detachably to the casting mold base element, and for the side wall ring element to be detached and removed from the casting mold base element before or after the exposure step. The side wall ring element can be formed in two parts, for example, and composed of two half-rings, which can be removed again following curing of the carrier material.

The side wall ring element can be manufactured like the casting mold base element from a metal or from a high-strength, dimensionally stable plastic material. The casting mold preferably consists of a material to which the carrier material does not adhere, so that simple demolding is facilitated. If applicable the side wall ring element can also be manufactured from another material than the casting mold base element. Due to the detachment and removal of the side wall ring element from the casting mold base element, an area of the carrier material between the carrier element and the casting mold base element becomes freely accessible, so that the carrier material and the connecting elements as well as the positioning elements, if necessary, can be severed in this area using normal mechanical separation methods such as cutting or sawing, for example, and the carrier element can be separated from the casting mold base element without the carrier element or the casting mold being damaged in the process.

The casting mold, the position of which relative to the carrier element is precisely determined by the positioning elements and is known, can serve in subsequent machining steps to fix the workpiece in a locating device provided for this. Renewed referencing of the workpiece is not absolutely necessary. The subsequent machining steps can be carried out without any time loss and with high spatial precision.

It is likewise possible and expedient for various applications for the carrier material with the workpiece and with the positioning elements to be removed from the casting mold and fixed in a positioning device before subsequent machining of the workpiece takes place. With a suitable choice of carrier material, the carrier material can be demolded from the casting mold, wherein an outer contour of the carrier material preset by the casting mold is retained, which contour can then be used for the precise arrangement and fixing of a block of carrier material demolded from the casting mold. The shaping of the molding formed by the carrier material can be adapted to standardized or given locating devices of machining machines.

According to an advantageous configuration of the inventive idea, it is provided that following fixing of the carrier material in the positioning device, the positioning elements projecting from the carrier material are scanned and used for a renewed referencing of the workpiece if necessary. An increase in the referencing accuracy is possible by this in that the positioning elements that have a precisely predetermined position relative to the workpiece are scanned. The accuracy of the positional determination of the workpiece relative to a machining tool that is to be used for the machining step is improved in this way and more precise post-machining can be carried out.

In many cases it is advantageous that a curing casting compound, an embedding compound or a suitable wax is used as carrier material. Various plastics or resins can also be used as carrier material. It is likewise possible to use a suitable thermoplastic plastic material as carrier material, which is heated following the machining step and can thereby be removed free of residue from the workpiece. The carrier material can be transparent or opaque in a cured state to permit optical inspection of the workpiece embedded therein. Furthermore, it is likewise conceivable to use a suitable thixotropic material as carrier material. A large number of previously named carrier materials and their properties are known in practice. They can easily be cast into the casting mold and ablated or removed again successively following curing in order to expose the embedded workpiece again.

According to one configuration of the inventive idea considered as particularly advantageous, it is provided that an alloy, a eutectic alloy and preferably a eutectic alloy with indium and/or bismuth is used as carrier material. An alloy composed of two or more metals permits especially great mechanical stability and strength when fixing the workpieces embedded therein and thus high precision in the positioning and subsequent machining of the workpieces. A particularly low melting temperature can be enabled with a eutectic alloy. For example, the energy outlay both for filling of the casting mold with the liquefied eutectic alloy before machining of the workpieces and for suitable liquefaction and removal of the carrier material from the workpieces without residues following machining of the workpieces can be reduced by this. A eutectic alloy of the metals indium and bismuth appears particularly advantageous, as this alloy has a low melting temperature of around 72° C. on the one hand and on the other hand is composed of metals that are non-toxic for living beings. Other alloys and eutectic alloys are also known that likewise have advantageous properties for use as a carrier material. Thus low-melting alloys are known based on indium, for example Field's metal, or low-melting alloys based on bismuth, for example Wood's alloy, or also low-melting alloys based on gallium, which are each commercially available and can be used depending on the requirements in each individual case.

The disclosure also relates to a device for locating and machining a workpiece with a carrier element, on which the workpiece can be arranged and fixed. The device may have a casting mold, which can be detachably connected to the carrier element and which encloses the workpiece and can be filled with a carrier material enclosing the workpiece. The casting mold can have one or more filling openings, for example, for the carrier material. The filling openings can be configured to be closed.

According to one configuration of the inventive idea, it is provided that the device has positioning elements connectable to the carrier element, which positioning elements can each be brought into engagement with a recess adapted thereto in the casting mold, in order to specify a positioning of the carrier element relative to the casting mold. The positioning elements can be projecting moldings, which are formed on the carrier element. The positioning elements can also be positioning pins or positioning cones, which can be fixed on the carrier element. The casting mold has recesses adapted to these, in which the positioning elements can engage to specify the position of the casting mold precisely and reliably relative to the carrier element. Furthermore, the end areas of the positioning elements engaging in the recesses in the casting mold are shielded from the carrier material and project from the cured carrier material following demolding of the casting mold, so that the end areas of the positioning elements can be used for subsequent scanning and referencing of the workpiece without a preceding exposure of the end areas of the positioning elements becoming necessary.

To this end it is provided that the recesses in the casting mold provided for engagement with a positioning element each have a seal, with which a gap is sealed between the positioning element and the adjoining area of the casting mold, so that no carrier material can penetrate into the recess. The seal can be an annular seal, for example, with a sealing ring inserted into a groove.

It is likewise possible that the positioning elements are formed on the casting mold or connected to the casting mold and can engage in recesses adapted thereto in the carrier element. Furthermore, it is likewise conceivable that only one positioning element is provided. The one positioning element is expediently not formed rotationally symmetrically, in order to facilitate clear positioning and fixing of the casting mold relative to the carrier element. Three or more positioning elements are preferably provided at the greatest possible distance from one another, in order to make a clear positional determination easier.

According to a particularly advantageous configuration of the inventive idea, it is provided that the casting mold is configured in two or in multiple parts and the multiple parts of the casting mold can be connected detachably to one another.

Advantageous handling of the casting mold during the implementation of the disclosed method can be made easier in that the casting mold has a casting mold base element and a multipart side wall ring element connectable detachably thereto. The side wall ring element is expediently formed in two or multiple parts and configured so that the side wall ring element, after filling of the casting mold with the carrier material and following its curing, can be detached and removed from the casting mold base element, so that the carrier element and the casting mold base element continue to enclose the carrier material, but are separated from one another by an annular area originally covered by the side wall ring element. This area, in which the carrier material with the connecting elements arranged therein lies exposed, can then be used in a simple manner to separate the carrier element from the casting mold base element and the carrier material located therein with the workpiece embedded in it.

Exemplary embodiments of the inventive idea are explained in greater detail below and depicted by way of example in the drawings.

### BRIEF DESCRIPTION OF THE DRAWINGS

FIG. 1 to FIG. 5 show schematic snapshots during the manufacture and machining of two workpieces by the disclosed method and using the disclosed device.

FIG. 6 shows a schematic snapshot before an embedding step, wherein several workpieces are additionally connected to one another by stabilizing elements.

FIG. 7 is a schematic depiction of a molding formed of a cured carrier material, in which two workpieces and three positioning elements are embedded.

FIG. 8 is a schematic depiction of the molding depicted in FIG. 7, which is taken up in a locating device of a machining machine and permits simultaneous machining of the two workpieces from opposing outer surfaces,

FIG. 9 is an enlarged partial view of a sealed recess in a casting mold in which a positioning element engages.

FIG. 10 is an enlarged partial view of an edge area of the molding formed from the cured carrier material in the casting mold, wherein a fixing element was inserted into the edge area as an insert component during the embedding step.

FIG. 11 is an enlarged partial view of the molding from the carrier material depicted in FIG. 10, wherein the casting mold was removed and a portion of the fixing element exposed, in order to make a gripping section of the fixing element accessible.

### DETAILED DESCRIPTION

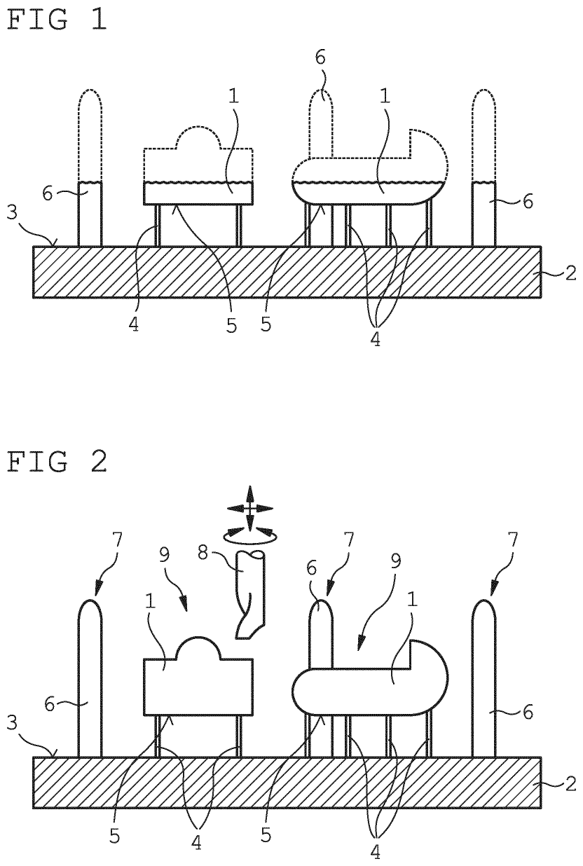

FIGS. 1 to 5 show several snapshots of a manufacturing and machining method. FIG. 1 schematically depicts a manufacturing step, wherein using a generative manufacturing process such as 3D printing or selective laser melting, for example, two workpieces 1 are generated and solidified in layers on a carrier element 2 configured in the shape of a disc. The carrier element 2 here is taken up in a locating device, which is not shown in greater detail, and is fixed in its position and situation. The two workpieces 1 are arranged on a level surface 3 of the carrier element 2 and each connected to the carrier element 2 and fixed thereto via several connecting elements 4. An underside 5 of the workpieces 1 has a spacing of, for example, one or more millimeters from the surface 3 of the carrier element 2.

At the same time as the generative manufacture of the two workpieces 1, several positioning elements 6 are produced generatively. The positioning elements 6 are formed pin-shaped, project perpendicularly from the level surface 3 of the carrier element 2 and have a rounded end area 7. In contrast to the two workpieces 1, the positioning elements 6 are connected not via connecting elements 4 but directly on and to the carrier element 2 and fixed thereon.

In a following first machining step (FIG. 2), the finished workpieces 1 could be machined with a suitable machining tool 8. Surface post-machining of the workpieces 1 can be undertaken with the machining tool 8, for example. However, on account of the fixing of the workpieces 1 on the carrier element 2, only one side 9 of the workpieces 1 facing away from the carrier element 2 is accessible to the machining tool 8 in each case, so that only the side 9 facing away from the carrier element 2 can be machined using the machining tool 8. Such a first machining step is not absolutely necessary in many cases.

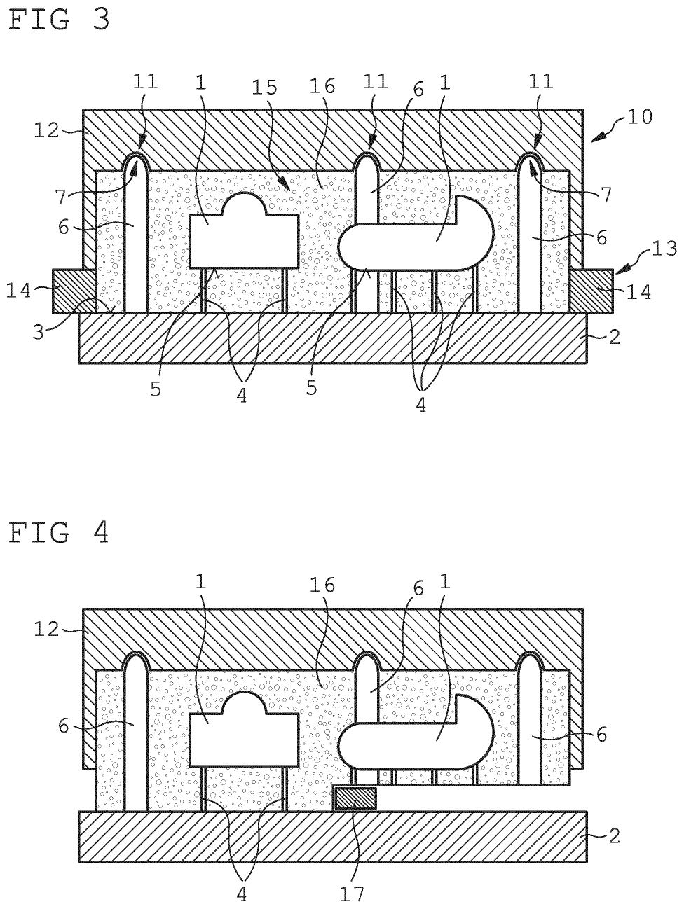

In a subsequent embedding step shown schematically in FIG. 3, a casting mold 10 is connected after the first machining step to the carrier element 2, wherein the casting mold 10 encloses the two workpieces 1 as well as the positioning elements 6. The positioning elements 6 engage with the end areas 7 in recesses 11 adapted thereto in the casting mold 10 and form a positive-locking positioning and positional fixing of the casting mold 10 relative to the carrier element 2. The positioning elements 6 embedded together with the workpieces 1 also form measuring points, the position of which is exactly specified. The positioning elements 6 can also be scanned prior to a subsequent machining step and used for referencing of the workpieces 1.

The casting mold 10 consists of a casting mold base element 12 formed in a pot-like manner and of a side wall ring element 13, which is formed in turn from two half-rings 14 formed in a half-ring shape. The half-rings 14 can be assembled detachably with one another to form the annular side wall ring element 13 and be connected likewise detachably to the casting mold base element 12 and removed from the casting mold base element 12 at a later time.

The casting mold 10 connected to the carrier element 2 forms a hollow cavity 15, in which the two workpieces 1 are arranged. Introduced into the hollow cavity 15 is an initially liquid carrier material 16, with which the hollow cavity 15 is filled and the two workpieces 1 completely enclosed. The initially liquid carrier material 16 then cures. The two workpieces 1 are then completely enclosed by the carrier material 16 and embedded therein, so that the workpiece 1 and the positioning elements 6 are fixed by the surrounding cured carrier material 16 in their position inside the casting mold 10.

The casting mold 10 can be taken up in a locating device, which is not depicted in greater detail, and fixed in its position.

In a subsequent exposure step depicted schematically in FIG. 4, the two half-rings 14 are detached from one another and from the casting mold base element 12 as well as from the carrier element 2 and are removed. The carrier element 2 is then separated from the casting mold 10 and the carrier material 16 cured therein along the level surface 3 using a band saw 17. To separate the carrier element 2 any suitable mechanical separating apparatus, for example a blade or saw, can be used. The carrier element 2 can also be eroded. In this case a thin slice of the carrier material 16 in an area close to the surface 3 of the carrier element 2 can be destroyed. During the separation of the carrier element 2 the positioning elements 6 and the connecting elements 4 that have connected the workpieces 1 to the carrier element 2 are also severed.

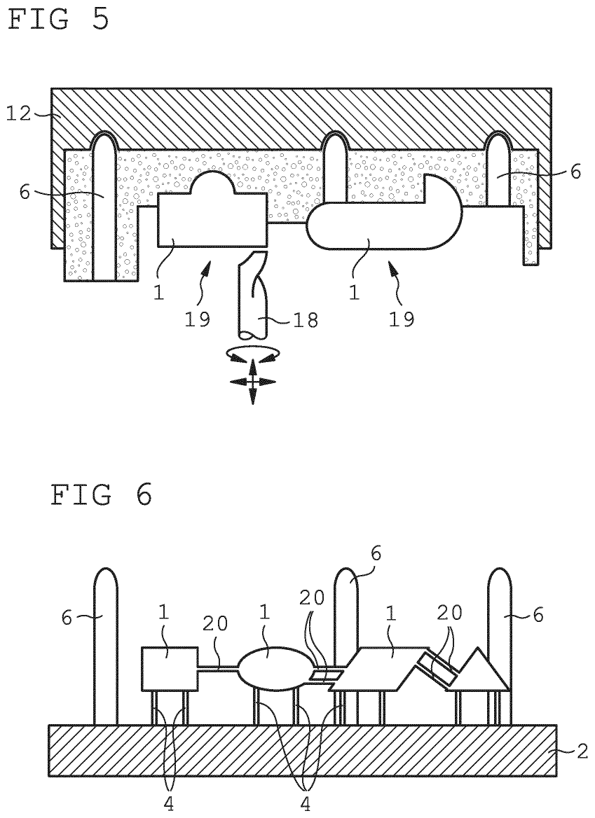

The two workpieces 1 can then be exposed as required from a side 19 originally facing the carrier element 2 using a suitable machining tool 18, in order to facilitate machining of the two workpieces 1 from the side 19 originally facing the carrier element 2 in a following second machining step, as is shown schematically in FIG. 5. After machining of the two workpieces 1 now from all sides 9, 19, the workpieces 1 can be completely removed from the carrier material 16. The carrier material 16 can be first taken out of the casting mold base element 12 or demolded for this purpose. The carrier material 16 can then be removed completely and without residues from the workpieces 1 using suitable methods.

In the exemplary embodiment shown by way of example in FIG. 6, several small workpieces 1 are connected to one another by stabilizing elements 20 for the purpose of additional stabilization. The stabilizing elements 20 can be produced using the normal generative manufacturing processes together with the workpieces 1 and the positioning elements 6. A number of small workpieces 1 can be reliably fixed on a carrier element 2 in this way and machined from all sides using the disclosed method. The positioning elements 6 can also be connected to the workpieces 1 by stabilizing elements 20 to achieve additional stability and more accurate referencing.

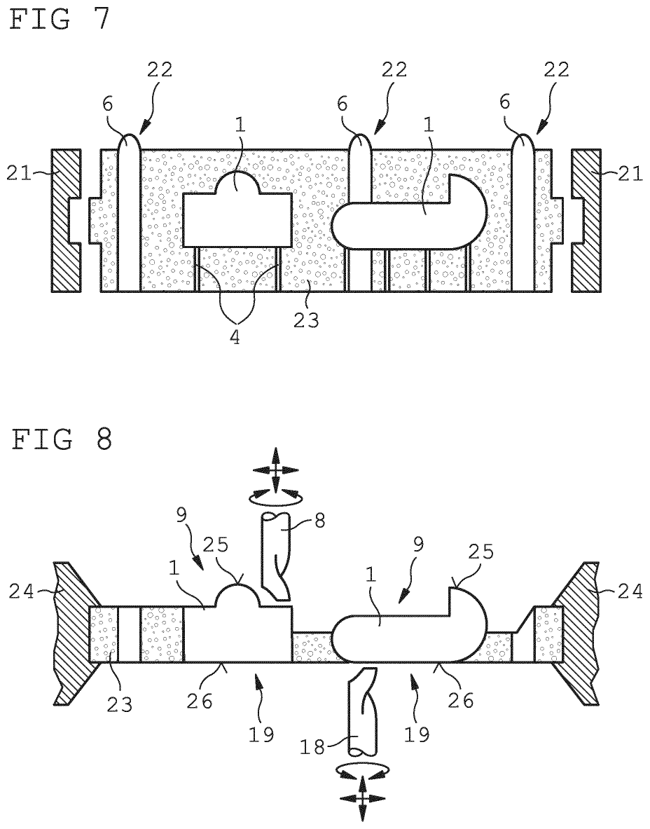

An advantageous configuration of the method is depicted by way of example in FIGS. 7 and 8. Following the manufacture of the workpieces 1 and the positioning elements 6 on the carrier element 2, a casting mold 10 formed of two half-ring-shaped wall shells 21 is placed onto the carrier element 2 so that the workpieces 1 and the positioning elements 6 are enclosed by the two half-ring-shaped wall shells 21. In the embedding step the curing carrier material 16 is then poured into the casting mold 10, wherein the filling level for the carrier material 16 is measured so that upper end areas 22 of the positioning elements 6 are not covered by the carrier material 16 and they project. Following the curing of the carrier material 16, the two half-ring-shaped wall shells 21 are demolded and the carrier element 2 separated from the remaining molding 23. The two workpieces 1 and the positioning elements 6 are embedded in the molding 23, the outer shape of which was determined by the casting mold 10 in the area of a circumferential sheath.

Following take-up of the molding 23 in a locating device 24 indicated in FIG. 8, the end areas 22 of the positioning elements projecting from the molding 23 can be scanned and used for referencing of the workpieces 1 in the molding 23. Very accurate positional recording of the workpieces 1 in the molding 23, which is taken up in the locating device 24 and fixed in position, is possible by this.

In a subsequent machining step, surfaces 25 and 26 lying opposite one another can then be machined simultaneously or consecutively using suitable machining tools 8, 18, without the molding 23 having to be removed from the locating device 24 and located afresh, and without gripping adversely affecting the preceding referencing and thus the precision achievable in machining of the workpieces 1.

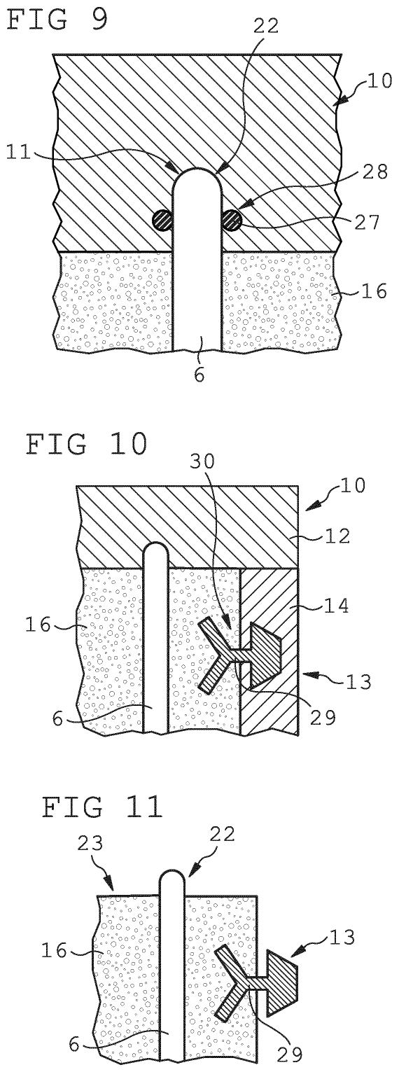

FIG. 9 depicts a recess 11 in the casting mold 10 in an enlarged view by way of example. An end area 22 of a positioning element 6 protrudes during the embedding step into the recess 11. To prevent the still liquid carrier material 16 from penetrating into the recess 11 through a gap between the positioning element 6 and the area of the casting mold 10 bordering the recess prior to curing, a sealing ring 27 is inserted into a groove 28 running along the circumference of the recess 11. The sealing ring 27 seals the annular gap between the positioning element 6 and the casting mold 10 and prevents the end area 22 of the positioning element 6 from being moistened and coated by the carrier material 16.

FIGS. 10 and 11 show purely schematically that during the embedding step, additional fixing elements 29 can also be embedded as an insert part in an edge area 30 on the casting mold 10 in a connecting area of the two half-rings 14 of the side wall ring element 13 in such a way in the molding 23 formed by the carrier material 16 that a gripping section 31 of the fixing element 29 is surrounded by the two half-rings 14 and an anchoring area of the fixing element 29 is embedded into the carrier material 16. Following the curing of the carrier material 16, the casting mold 10 can be demolded in order to expose the gripping section 31 of the fixing element 31, which continues to be anchored in the remaining molding 23. The exposed gripping section 31 can be used to grip the molding 23 before a subsequent machining step and to take it up and fix it in a suitable locating device of a machining machine.

In an advantageous configuration of the method, first the workpieces 1 and the positioning elements 6 are produced with the aid of a generative manufacturing method on the carrier element 2. Then the workpieces 1 and the positioning elements 6 are enclosed in an embedding step by a casting mold 10 and embedded in a curing carrier material 16. The casting mold 10 and the carrier element 2 are demolded and separated from the molding 23 formed from the cured carrier material 16. The molding 23 is taken up in a locating device 24 and fixed in position. The end areas 22 of the positioning elements 6 protruding from the molding 23 are scanned and the workpieces 1 embedded in the molding 23 are referenced, so that their position relative to the locating device 24 is exactly known. Then the surfaces 25, 26 of the workpieces 1 can be post-machined in a subsequent machining step with suitable machining tools 8, 18.

1.-21. (canceled)

22. A method for machining a workpiece which is fixed on a carrier element by at least one connecting element, comprising:
an embedding step, in which the workpiece is inserted into a casting mold enclosing the workpiece and a curing carrier material enclosing the workpiece is introduced into the casting mold, so that the workpiece is embedded and fixed in the carrier material;
an exposure step, in which the carrier element is separated from the workpiece and the workpiece is exposed from a side facing the carrier element; and
a subsequent machining step, in which the workpiece partially embedded in the carrier material is machined.

23. The method according to claim 22,
wherein the workpiece is manufactured on the carrier element by a generative manufacturing process and at least one connecting element connecting the workpiece to the carrier element is also manufactured.

24. The method according to claim 22,
wherein positioning elements are arranged on the carrier element or on the workpiece.

25. The method according to claim 24,
wherein, on introduction of the workpiece into the casting mold, the projecting positioning elements engage in recesses adapted thereto in the casting mold in order to specify a positioning of the carrier element with the workpiece fixed thereon relative to the casting mold.

26. The method according to claim 24,
wherein at least three positioning elements are arranged spaced at an interval from one another.

27. The method according to claim 24,
wherein the positioning elements are positioning pins projecting from the carrier element.

28. The method according to claim 24, wherein the positioning elements are each connected by way of at least one connecting element to the carrier element.

29. The method according to claim 24,
wherein the positioning elements are connected to the workpiece via stabilizing elements.

30. The method according to claim 24, wherein the positioning elements are manufactured together with the workpiece by a generative manufacturing method.

31. The method according to claim 22,
wherein the casting mold is configured in multiple parts and following the curing of the carrier material is taken apart and demolded from the cured carrier material.

32. The method according to claim 31,
wherein the casting mold has
a casting mold base element and
a side wall ring element connectable detachably to the casting mold base element, and
wherein the side wall ring element is detached and removed from the casting mold base element before or after the exposure step.

33. The method according to claim 24,
wherein the carrier material is removed from the casting mold with the workpiece and with the positioning elements and is fixed in a positioning device before subsequent machining of the workpiece takes place.

34. The method according to claim 33,
wherein following the fixing of the carrier material in the positioning device, the positioning elements projecting from the carrier material are scanned and used for referencing of the workpiece.

35. The method according to claim 33,
wherein during the embedding step, at least one fixing element is embedded into the carrier material in an edge area facing the casting mold, which element is partly exposed following curing of the carrier material and is used for locating in a positioning device.

36. The method according to claim 22,
wherein the carrier material is a curing molding compound, an embedding compound, a wax or a thermoplastic plastic material.

37. The method according to claim 22, wherein the carrier material is a eutectic alloy.

38. A device for locating and machining a workpiece, comprising:
a carrier element, on which the workpiece can be arranged and fixed; and
a casting mold, which can be connected detachably to the carrier element, and which encloses the workpiece and can be filled with a carrier material enclosing the workpiece.

39. The device according to claim 38,
wherein the device has positioning elements connectable to the carrier element, which positioning elements can each be brought into engagement with a recess adapted thereto in the casting mold, in order to specify a positioning of the carrier element relative to the casting mold.

40. The device according to claim 39,
wherein the recesses in the casting mold provided for engagement with a positioning element each have a seal, with which a gap between the positioning element and an adjoining area of the casting mold is sealed, so that no carrier material can penetrate into the recesses.

41. The device according to claim 38,
wherein the casting mold is configured in two parts or multiple parts and the multiple parts of the casting mold are connectable detachably to one another.

42. The device according to claim 41,
wherein the casting mold has a casting mold base element and a multipart side wall ring element detachably connectable thereto.
